(19) United States
(12) Patent Application Publication
(10) Pub. No.: US 2018/0311596 A1
(43) Pub. Date: Nov. 1, 2018

(54) LAMINAR FLOW IN CARBON DIOXIDE BASED CHROMATOGRAPHY

(71) Applicant: Waters Technologies Corporation, Milford, MA (US)

(72) Inventors: Abhijit Tarafder, Franklin, MA (US); Jason F. Hill, Milford, MA (US)

(21) Appl. No.: 15/967,686

(22) Filed: May 1, 2018

Related U.S. Application Data
(60) Provisional application No. 62/492,393, filed on May 1, 2017.

(51) Int. Cl. B01D 15/18; G01N 30/54; B01D 15/16; B01D 15/40

(52) U.S. Cl. CPC B01D 15/18; G01N 30/54; G01N 2030/027; B01D 15/40; B01D 15/163; B01D 15/161

(57) ABSTRACT

The present disclosure relates generally to a system of method development in a highly-compressible fluid based chromatography system. In particular, the disclosure relates to method development in a carbon dioxide based chromatography system which can avoid non-laminar flow conditions. The system can include characterization of the chromatographic system in the form of one or more charts that can be used during method development to select chromatographic separation conditions that avoid non-laminar flow. For example, the onset of non-laminar conditions can be plotted as a function of volumetric flow rate and the mobile phase composition, e.g., carbon dioxide: methanol (v/v %).

### RELATED APPLICATIONS

This application claims priority to U.S. Provisional Application No. 62/492,393, filed on May 1, 2017, entitled “Laminar Flow in Carbon Dioxide Based Chromatography”, and which is incorporated herein by reference in its entirety.

### TECHNICAL FIELD

The present disclosure relates generally to method development in a highly-compressible fluid based chromatography system, such as a carbon dioxide based chromatography system. In particular, the present disclosure relates to method development in a carbon dioxide based chromatography system which can avoid non-laminar flow conditions.

### BACKGROUND OF THE INVENTION

Chromatographic separations are generally more efficient when performed under laminar flow conditions. Laminar flow conditions are where the mobile phase flows in parallel layers with little to no disruption between the layers. Under laminar flow conditions, which are typically at lower velocities, the mobile phase tends to flow without substantial lateral mixing and adjacent layers slide past one another. There are few, if any, cross-currents perpendicular to the direction of flow, eddies or swirls within the mobile phase. In laminar flow, the motion of the mobile phase particles is very orderly with the particles moving in straight lines parallel to walls or boundaries. Under non-laminar or turbulent flow conditions, which are typically at higher velocities, the flow is less orderly and can be characterized by eddies or small packets of particles which result in lateral mixing. Non-laminar conditions can also lead to higher pressure drops of the mobile phase along the chromatographic system, which can be undesirable.

Under most sets of conditions, liquid chromatography systems operate under laminar flow conditions. Highly-compressible fluid based chromatography systems, however, may not. Highly-compressible fluid based chromatography systems have mobile phases with viscosities up to 20 times lower than liquid chromatography systems. As a result, a highly-compressible fluid based mobile phase can experience a transition from laminar to non-laminar flow under more typical operating conditions.

### SUMMARY OF THE INVENTION

The present disclosure relates generally to a system of method development in a highly-compressible fluid based chromatography system (e.g., CO₂-based system or other such system utilizing a mobile phase that experiences large variations in density with small fluctuations in temperature and/or pressure) which can avoid non-laminar flow conditions.

In one embodiment, the present disclosure relates to a method for developing a carbon dioxide based chromatography separation including (i) providing a chromatography system having a pump for pumping a mobile phase containing carbon dioxide and a modifier, a column disposed downstream of the pump and connected to the pump with a first section of tubing, a detector disposed downstream of the column and connected to the column with a second section of tubing, and a back pressure regulator downstream of the detector and connected to the detector with a third section of tubing, (ii) selecting a first set of chromatography conditions including the percent carbon dioxide and the percent modifier in the mobile phase, a system temperature, a system pressure, and a mobile phase flow rate, and (iii) determining if the chromatography system at the first set of chromatography conditions exhibits laminar flow, wherein the determination is derived from at least one chart showing the relationship between laminar flow and the first set of chromatography conditions for the system.

In another embodiment, the present disclosure relates to a method of developing a laminar flow condition chart for a carbon dioxide based chromatography system including (i) providing a chromatography system having a pump for pumping a mobile phase containing carbon dioxide and a modifier, a column disposed downstream of the pump and connected to the pump with a first section of tubing, a detector disposed downstream of the column and connected to the column with a second section of tubing, and a back pressure regulator downstream of the detector and connected to the detector with a third section of tubing, (ii) selecting a first set of chromatography conditions including the percent carbon dioxide and the percent modifier in the mobile phase, a system temperature, a system pressure, and a mobile phase flow rate, (iii) determining the volumetric flow rate that equates to a Reynolds number value of about 2000 for the first set of chromatography conditions, (iv) selecting a second set of chromatography conditions wherein the percent carbon dioxide and the percent modifier in the mobile phase, the system temperature, the mobile phase flow rate, or combinations thereof are changed from the first set of conditions, (v) determining the volumetric flow rate that equates to a Reynolds number value of about 2000 for the second set of chromatography conditions, (vi) repeating steps (iv) and (v) until at least one line is capable of being plotted, and (vi) plotting the volumetric flow rates against the mobile phase composition at different temperatures from the sets of chromatographic conditions to generate a laminar flow condition chart.

In another embodiment, the present disclosure relates to a chromatographic system including (i) a pump for pumping a mobile phase containing carbon dioxide and a modifier at a system pressure and a mobile phase flow rate, (ii) a column disposed downstream of the pump, (iii) a detector disposed downstream of the column, (iv) a back pressure regulator disposed downstream of the detector, wherein at least two of the system components are connected with at least one section of tubing, (v) at least one temperature sensor configured to measure the temperature of the mobile phase in the at least one section of tubing, (vi) at least one heater in thermal communication with the at least one section of tubing, wherein the heater is configured to adjust the temperature of the mobile phase in the at least one section of tubing, and (vi) at least one temperature controller in signal communication with the at least one sensor and the at least one heater. The controller can be configured to receive a first temperature measurement from the sensor, determine if the mobile phase in the at least one section of tubing exhibits laminar flow, wherein the determination is derived from at least one chart showing the relationship between laminar flow and the weight or volume percent composition of the mobile phase, the system pressure, the mobile phase flow rate and the first temperature measurement from the at least one sensor, determine a desired temperature of the mobile phase in the at least one section of tubing that exhibits laminar flow, wherein the determination is derived from at least one chart showing the relationship between laminar flow and the weight or volume percent composition of the mobile phase, the system pressure and the mobile phase flow rate, and send a signal to the at least one heater to adjust the temperature of the mobile phase in the at least one section of tubing to the desired temperature. The at least one section of tubing can include a section of tubing between the column and the detector.

In another embodiment, the present disclosure relates to a chromatographic system wherein at least three or more of the system components disclosed above are connected with at least two or more sections of tubing, the system including at least two or more temperature sensors configured to individually measure the temperature of the mobile phase in the at least two sections of tubing, at least two heaters each in thermal communication with one of the at least two sections of tubing, wherein the heaters are configured to individually adjust the temperature of the mobile phase in each of the at least two sections of tubing, and at least one temperature controller in signal communication with the at least two sensors and the at least two heaters. The controller can be configured to receive first temperature measurements from the at least two sensors, individually determine if the mobile phase in each of the at least two sections of tubing exhibits laminar flow, wherein each determination is derived from at least one chart showing the relationship between laminar flow and the weight or volume percent composition of the mobile phase, the system pressure, the mobile phase flow rate and the first temperature measurements from each of the at least two sensors, determine a desired temperature of each mobile phase in the at least two sections of tubing that exhibit laminar flow, wherein each determination is derived from at least one chart showing the relationship between laminar flow and the weight or volume percent composition of the mobile phase, the system pressure and the mobile phase flow rate, send a signal to each of the at least two heaters to individually adjust the temperature of the mobile phase in the at least two sections of tubing to the desired temperatures. The at least two sections of tubing can include a section of tubing between the column and the detector, and between the detector and the back pressure regulator.

The methods and charts of the present disclosure provide several advantages over the prior art. Currently, the determination of laminar or non-laminar flow conditions in a carbon dioxide based chromatography system is time consuming and impractical. The determination involves collecting relevant physical property data at each set of conditions and calculating the Reynolds number for each set. The present disclosure provides a chart that easily estimates the demarcation between laminar and non-laminar flow conditions. For example, the chart can easily and visually demarcate flow rates (as a function of the volumetric percent of mobile phase components, temperature, etc.) which can lead to non-laminar flow inside a portion of tubing within a carbon dioxide based chromatography system.

The laminar flow condition chart of the present disclosure can be a plot of mobile phase composition, e.g., carbon dioxide/methanol (v/v %), as a function of volumetric flow rate at a fixed temperature, pressure, and/or tube diameter for when the Reynolds number value (Re) is about 2000. On this exemplary chart, for a given mobile phase composition, any flow rate higher than the flow rate representing Re of 2000 may result in non-laminar flow conditions, and as such in some embodiments can be considered non-laminar flow conditions. The laminar flow condition chart that can be generated for a carbon dioxide based chromatography system can be used during method development to quickly determine, i.e., determine without experimental testing, if a flow rate may result in non-laminar flow in the connecting tubes through which the mobile phase is flowing. Knowing if and when a flow inside a connecting tube (e.g., tubing or connecting pipes or portions defining a flowpath) can transition to a non-laminar condition can be useful to because the transition can affect the chromatography, e.g., retention time, resolution, etc.

### BRIEF DESCRIPTION OF THE DRAWINGS

The foregoing and other features and advantages provided by the present disclosure will be more fully understood from the following description of exemplary embodiments when read together with the accompanying drawings, in which:

FIG. 1 shows an exemplary example of the effect of non-laminar flow on limiting the operating pressure range in a chromatography system. R. De Pauw et al, Journal of Chromatography A, 1361 (2014) 277-285. The change in pressure across the tubing and the column were measured in a carbon dioxide based system having a 4.6 mm i.d. column (150 mm length, 5 micron particles) and 120 micron i.d. tubing (45 cm length). The mobile phase was carbon dioxide having 10 vol% methanol. As the flow rate increases beyond 1 mL/min the flow in the tubing becomes non-laminar and the tubing pressure drop increases significantly compared to the column pressure drop.

FIG. 2 shows another exemplary example of the effect of non-laminar flow on the performance of a chromatography system. A change in pressure across the tubing can interfere with the use of the average-column-pressure as a tool to transfer methods between different systems. A carbon dioxide based chromatography system having a 3 mm i.d. column (50 mm length, 1.7 micron particles) was used. Successive separations at different flow rates were held at an average-column-pressure of 3675 psi. As the flow rate was increased (from 0.5-4 mL/min) the separation initially remains unaffected. At a flow rate of about 2.5 mL/min non-laminar flow was observed and the separation was negatively affected (e.g., peak drift occurs). The pressure drop across the tubing and column were determined using individual pressure transducers placed across each section (e.g., front/back of tubing or front/back of column).

FIG. 3 shows an exemplary laminar flow condition chart for a carbon dioxide based chromatography system having 0.007 inch internal diameter (i.d.) tubing, and held at a pressure of about 2000 psi. The chart shows laminar flow boundary lines for the system at different temperatures, mobile phase compositions (v/v) and flow rates (mL/min). The region to the left-hand side of a boundary line represents laminar flow conditions, whereas the region to the right-hand side represents non-laminar flow conditions.

FIGS. 4A and 4B show an exemplary laminar flow condition chart for a carbon dioxide based chromatography system having 0.007 inch internal diameter (i.d.) tubing, and held at a pressure of about both 2000 psi and 4000 psi for various operating temperatures, in two different formats. FIG. 4A shows the chart in volume percent methanol within the carbon dioxide flow, whereas FIG. 4B shows the chart in weight percent methanol.

FIGS. 5A and 5B show an exemplary laminar flow condition chart for a carbon dioxide based chromatography system having 0.009 inch internal diameter (i.d.) tubing, and held at a pressure of about both 2000 psi and 4000 psi for various operating temperatures, in two different formats. FIG. 5A shows the chart in volume percent methanol within the carbon dioxide flow, whereas FIG. 5B shows the chart in weight percent methanol.

FIG. 6 shows an exemplary chromatography system including a pump, column, detector, and back pressure regulator connected by tubing. Two thermal jackets (e.g., heaters) cover the tubing between the column, detector and regulator to control the temperature of the mobile phase in the tubing sections and, thus, control the flow conditions. In this figure, an injector (a standard and well-known part of a chromatography system) is not shown, as the figure has been provided to illustrate connecting sections most relevant to the present technology.

FIG. 7 shows the progression of turbulent flow region with varying tubing internal diameter (e.g., from 0.005 inches to 0.02 inches) at 40 C and 2000 psi (138 bar).

### DETAILED DESCRIPTION

The present disclosure relates generally to a system of method development in a highly-compressible fluid based chromatography system. In particular, the disclosure relates to method development in a carbon dioxide based chromatography system which can avoid non-laminar flow conditions.

As used herein the term “Reynolds number” or “Re” refers generally to the function:

$$Re = \frac{4 G}{{πμ}_{1} D} \qquad ( i )$$

The Reynolds number is used in fluid flow calculations to estimate whether the flow through a tube or pipe is laminar or turbulent in nature. G is the mass flow in g/min.; μ₁ is the viscosity in g/cm min.; and D is the tube or pipe diameter in cm. A Reynolds number value at or below about 2000 corresponds to laminar flow. A Reynolds number value at or above 5000 corresponds to turbulent flow. A Reynolds number value between about 2000 and 5000 indicates a buffer region where the flow can transition from laminar flow conditions to turbulent flow conditions. The mass flow rate and viscosity variables are not easily or readily available for each set of conditions for a highly compressible fluid based chromatography system. The methods and charts of the present disclosure can approximate, estimate or calculate these values from other system parameters, as needed.

Highly-compressible fluid chromatography is a type of chromatography that is configured to operate with a solvent that includes a fluid (e.g., carbon dioxide, Freon, etc.) that can be in a gaseous state at ambient/room temperature and pressure. Typically, highly-compressible fluid chromatography involves a fluid that experiences noticeable density changes over small changes in pressure and temperature. As such, mobile phase fluids, such as methanol and water under conventional HPLC or UHPLC operating conditions would not be considered to be a highly-compressible fluid chromatography system. Although highly-compressible fluid chromatography can be carried out with several different compounds, carbon dioxide is used as a reference compound as it is the currently the most commonly employed. Highly-compressible fluid chromatography has also been referred to as carbon dioxide based chromatography, or in some instances as supercritical fluid chromatography (SFC), especially where carbon dioxide is used as the mobile phase. In some embodiments, the mobile phase can contain at least 10%, 20%, 30%, 40%, 50%, 60%, 70%, 80%, 90%, 95%, 98% or about 100% highly-compressible fluid, e.g., carbon dioxide.

As used herein the term “carbon dioxide based chromatography system” refers generally to any chromatography system that uses a mobile phase including carbon dioxide, at least in part.

In one embodiment, the present disclosure relates to a method for developing a carbon dioxide based chromatography separation including (i) providing a chromatography system including a pump for pumping a mobile phase containing carbon dioxide and a modifier, a column disposed downstream of the pump and connected to the pump with a first section of tubing, a detector disposed downstream of the column and connected to the column with a second section of tubing; and a back pressure regulator downstream of the detector and connected to the detector with a third section of tubing, (ii) selecting a first set of chromatography conditions including the percent carbon dioxide and the percent modifier in the mobile phase, a system temperature, a system pressure, and a mobile phase flow rate, and (iii) determining if the chromatography system at the first set of chromatography conditions exhibits laminar flow, wherein the determination is derived from at least one chart showing the relationship between laminar flow and the first set of chromatography conditions for the system.

In another embodiment, the chromatography system can include a pump for pumping a mobile phase containing carbon dioxide and a modifier, an injector disposed downstream of the pump and connected to the pump with a first section of tubing, a column disposed downstream of the injector and connected to the injector with a second section of tubing, a detector disposed downstream of the column and connected to the column with a third section of tubing, and a back pressure regulator downstream of the detector and connected to the detector with a fourth section of tubing.

In another embodiment, the present disclosure relates to a method for developing a carbon dioxide based chromatography separation including providing a chromatography system having a pump for pumping a mobile phase containing a highly-compressible fluid and a modifier, an injector disposed downstream of the pump, a column disposed downstream of the injector, a detector disposed downstream of the column, and a back pressure regulator downstream of the detector, wherein at least two of the system components are connected with a section of tubing, selecting a first set of chromatography conditions including the percent carbon dioxide and the percent modifier in the mobile phase, a system temperature, a system pressure, and a mobile phase flow rate, and determining if the chromatography system at the first set of chromatography conditions exhibits laminar flow, wherein the determination is derived from at least one chart showing the relationship between laminar flow and the first set of chromatography conditions for the system. The method can further include wherein at least three of the system components are connected with at least two sections of tubing. The method can also include wherein all of the system components are connected with separate sections of tubing.

The method can further include selecting a second set of chromatography conditions including the percent carbon dioxide and the percent modifier in the mobile phase, the system temperature, the system pressure, and the mobile phase flow rate, determining if the chromatography system at the second set of chromatography conditions exhibits laminar flow, wherein the determination is derived from at least one chart showing the relationship between laminar flow and the second set of chromatography conditions for the system. These steps can be repeated until a set of conditions exhibiting laminar flow is determined.

Non-laminar flow can also be characterized by chaotic changes in mobile phase or system properties that can result in low momentum diffusion, high momentum convection, rapid variation of pressure or flow velocity in space and/or time, or combinations thereof. These changes in mobile phase or system properties can result in different performance variations in chromatography systems and operation thereof. For example, in a supercritical fluid chromatography system a transition from laminar to non-laminar flow can negatively influence the separation performance.

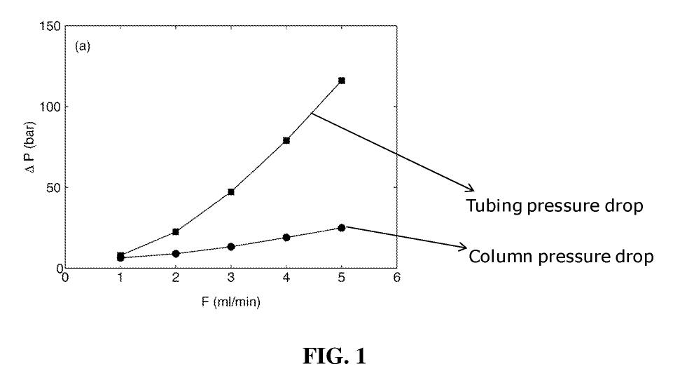

One such negative influence is the limiting of the operation pressure window. Under non-laminar flow conditions, e.g., at high flow rates, extra-column pressure drop may be much larger than the column pressure drop. See FIG. 1. A large extra-column pressure drop can limit the available column pressure drop of the chromatography system. A relatively large column pressure drop is advantageous. Separation conditions in chromatography are generally limited by the highest pressure achievable by the pump. Depending on the flow-rate, mobile-phase properties, column packing and particle diameter, the main source of high pressure should be due to the column. If there is a pressure drop in the tubing, it reduces the pressure window that could have been used by the column to have a higher flow rate or a lower particle size, etc. In one embodiment, the present disclosure relates to a system that minimizes extra-column pressure drop. The extra-column pressure can be less than or equal to about 2000 psi, 1900 psi, 1800 psi, 1700 psi, 1600 psi, 1500 psi, 1400 psi, 1300 psi, 1200 psi, 1100 psi, 1000 psi, 900 psi, 800 psi, 700 psi, 600 psi, 500 psi, 400 psi, 300 psi, 200 psi, 100 psi, 80 psi, 60 psi, 40 psi, 20 psi or about 10 psi. These values can also be used to define a range, such as about 1500 psi to about 100 psi.

The present disclosure relates to a system that maximizes the available window of column pressure drop in a chromatographic system (e.g., column in to column out). The column pressure drop across the chromatographic system, or applicable components, can be greater than or equal to about 50%, 55%, 60%, 65%, 70%, 75%, 80%, 85%, 90%, 95%, 98% or about 99% of the total pressure drop across the system or applicable components. These values can also be used to define a range, such as about 80% to 95% or about 90% to about 99%. The pressure drop can be divided into different parts, including pressure drop across the column versus pressure drop across all the other components, tubings, except the column. For example, the pressure drop can be measured between the pump and column-head, over the column, and between the column-end and ABPR.

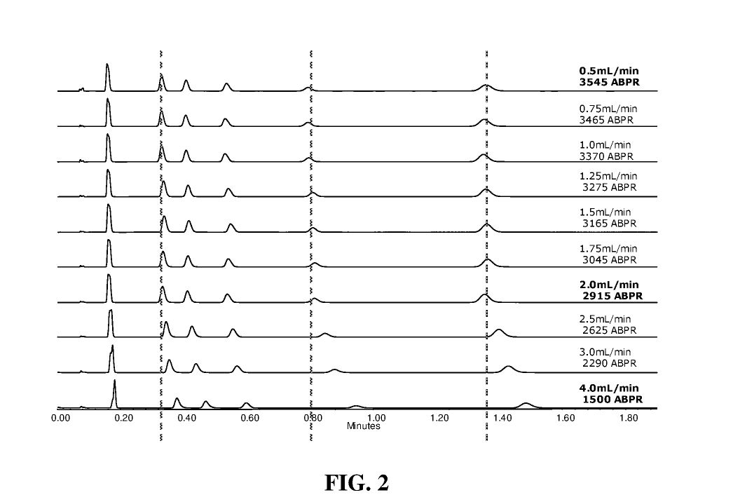

Another such negative influence of the additional pressure drop due to non-laminar flow conditions is the non-linear fashion of the pressure drop, which therein results in a non-linear increase in the average-column-pressure drop. During scale-up or method transfer, for instance, a separation on one system can be approximated on a second system by matching the average-column-pressure for both systems. The presence of non-laminar flow can result in erroneous or a more erroneous pressure drop across the column which can disrupt this matching approach. See FIG. 2.

The chromatography system of the present disclosure can be any chromatography system capable of non-laminar flow at various operating conditions, including highly-compressible fluid based chromatography, e.g., carbon dioxide based chromatography and supercritical fluid chromatography

The pump can be any pump capable of pumping a highly-compressible fluid (e.g., carbon dioxide based mobile phase) through a chromatography system. As used herein, the term capable of can include configured to or adapted to. The pump(s) can be capable of generating a multiple component mobile phase, e.g., carbon dioxide and at least one modifier. The pump can be capable of pumping the mobile phase as various flow rates including about 0.01 mL/min, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15, 20, 30, 40, 100, 200 or about 500 mL/min. These values can also be used to define a range, such as about 1 to about 10 mL/min, or about 100 to about 250 mL/min. The pump can be capable of generating various system pressures including about 800 psi, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5500, 6000, 6500, 7000, 7500, 8000, 8500, 9000, 9500 or about 10000 psi. These values can also be used to define a range, such as about 1500 to about 4000 psi.

The mobile phase can contain highly-compressible fluid, e.g., carbon dioxide, and at least one modifier. The mobile phase can contain at least 5%, 10%, 20%, 30%, 40%, 50%, 60%, 70%, 80%, 90%, 95%, 98%, 99% or about 100% carbon dioxide. These values can also be used to define a range, such as about 50% to about 90% carbon dioxide. The modifier can be any solvent capable of being used in a carbon dioxide based chromatography system, such a methanol, acetonitrile, isopropanol ethanol, dichloromethane, tetrahydrofuran or combinations thereof. In one embodiment, the modifier is methanol.

The column can be any column capable of separating at least one analyte in a highly-compressible fluid based chromatography system. The detector can be any detector capable of qualitatively, quantitatively, or both determining at least one analyte in a carbon dioxide based chromatography system. The back pressure regulator can be any back pressure regulator capable of regulating the pressure in a carbon dioxide based chromatography system. In some embodiments, the back pressure regulator is an active or automatic back pressure regulator.

The tubing can be any tubing capable of being used in a highly-compressible fluid based chromatography system and capable of withstanding the system pressures. The tubing can be made of plastic, metal, or combinations thereof. In some embodiments, the tubing can be copper, PVC, or brass tubing. The tubing can have a low surface roughness, as compared to stainless steel. The surface roughness can be less than about 0.005 mm, 0.0045, 0.004, 0.0035, 0.003, 0.0025, 0.002, 0.0015, 0.001 or about 0.0005 mm. These values can define a range, such as about 0.0015 to about 0.0025 mm.

The internal diameter of the tubing can vary depending on the chromatography system. The internal diameter of the tubing can be about 0.001″, 0.002, 0.003, 0.004, 0.005, 0.006, 0.007, 0.008, 0.009, 0.010, 0.011, 0.012, 0.013, 0.014, 0.015, 0.016, 0.017, 0.018, 0.019, 0.02, 0.03, 0.04, 0.05, 0.06, 0.07, 0.08, 0.09 or about 0.1″. These values can also be used to define a range, such as about 0.002″ to about 0.020″. In some embodiments, the internal diameter can be consistent along any one section of tubing. The tubing can have a smooth internal surface.

In some embodiments, the tubing section between column end and ABPR has a higher possibility for turbulent flow. The mobile phase temperature can be higher downstream of the column compared to upstream of the column. The pressure in this section can also be lower. Accordingly, the section(s) downstream of the column can have a lower viscosity and hence a higher possibility of having turbulent flow.

The different sections of tubing, i.e., between the pump and column, between the column and detector, etc., can be made of the same materials and have the same parameters. The different sections of tubing can also be made of different materials and have different parameters. In some embodiments, each tubing section is made of the same material and has the same internal diameter, e.g., the first, second and third section of tubing have the same material and internal diameter. In other embodiments, the different sections of tubing are made of different materials and have different internal diameters.

A first set of chromatography conditions for a particular carbon dioxide based chromatography system can be selected for evaluation of laminar flow conditions. The set of conditions can include the percent carbon dioxide and the percent modifier(s) in the mobile phase, a system temperature, a system pressure, a mobile phase flow rate, tube diameter, etc.

The percent carbon dioxide and the percent modifier(s) in the mobile phase, i.e., the mobile phase composition, can be any value between 99:1 to 10:90. For example, the ratio of carbon dioxide to modifier can be 99:1, 98:2, 97:3, 96:4, 95:5, 94:6, 93:7, 92:8, 91:9, 90:10, 89:11, 88:12, 87:13, 86:14, 85:15 or about 80:20. These values can define a range, such about 99:1 to about 90:10. The higher the content of highly-compressible fluid, the lower the viscosity and the higher possibility of having turbulent flow at standard operating conditions. The mobile phase composition can vary of the separation, such as in a gradient separation. The first set of conditions can be selected at the beginning of the gradient, the end of the gradient or at any point along the gradient separation.

The system temperature and pressure can vary depending on the application and the components within the system. The temperature of the system, or of any one component in the system, can be -10, -5, 0, 5, 10, 15, 20, 25, 30, 35, 40, 45, 50, 60, 70, 80, 90 or about 100° C. These values can also be used to define a range, such as about −10° C. to about 30° C.

In some embodiments, the different components or sections of tubing can be held at different temperatures to maintain laminar conditions. The higher the temperature, the lower the viscosity and hence the increase favors turbulence. At subzero temperatures, the viscosity can be high enough to stay within laminar region at normal operating conditions. For example, the temperature of the tubing downstream of the column can be kept at a lower temperature to avoid turbulent flow, as determined by the charts and disclosures herein The temperature(s) of the system, or of any components in the system, can be measured by the use of one or more thermocouples placed at, in or across the system or component.

The pressure of the system can be 800 psi, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5500, 6000, 6500, 7000, 7500, 8000, 8500, 9000, 9500 or about 10000 psi. These values can also be used to define a range, such as about 1500 to about 4000 psi. These values can also be used to define a range, such as about 2000 to about 4000 psi. The pressures can be measured by the instrument at the pump-outlet and at the ABPR inlet. Pressures across the column, or other components, can be measured with one or more additional pressure transducers.

The pressures(s) of the system, or of any components in the system, e.g., tubing sections, can be measured by the use of one or more pressure transducers placed at, in or across the system or component.

The mobile phase flow rate can be 0.01 mL/min, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 1.5, 2, 2.5, 3, 3.5, 4, 4.5, 5, 6, 7, 8, 9, 10, 15, 20, 30, 40, 100, 200 or about 500 mL/min. These values can also be used to define a range, such as about 0.1 mL/min to 5mL/min, about 1 to about 10 mL/min, or 100 to 250 mL/min. These values can also be used to define a range, such as about 1 to about 10 mL/min.

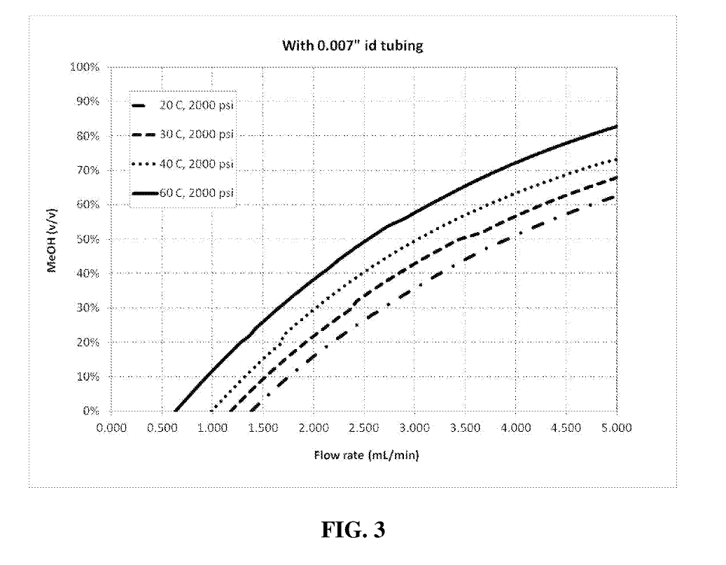

The chromatography system at the first set of chromatography conditions can be checked to determine if it is expected to exhibit laminar flow using at least one chart, e.g., a laminar flow condition chart, showing the relationship between laminar flow and the first set of chromatography conditions for the system. Exemplary charts are shown in FIGS. 3-5. The chart can be specific for the particular system, e.g., the hardware, column, tubing, etc. A change in any of the system components can be a change in the system and require the use of a new chart specific to that system.

In one embodiment, the chart is a plot of the mobile phase composition against the volumetric flow rate, as shown in FIGS. 3-5. The chart can be a laminar flow condition chart showing Reynolds number plot lines at a defined Reynolds number value for different sets of chromatography conditions. The Reynolds number value for the plot lines can be representative of a Reynolds number value of about 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, 4600, 4700, 4800, 4900, 5000, 5100 or about 5200. These values can also be used to define a range, such as about 1800 to about 2200. In one embodiment, the Reynolds number value for the plot lines is about 2000.

In another embodiment, the present disclosure can be useful in changing tube i.d. at a fixed flow rate. The charts can be useful for the proper selection of connecting tube diameters.

The determination of whether the system exhibits laminar flow can be made within or across any component subject to non-laminar flow conditions, e.g., any section of tubing within the system. In one embodiment, the determination is made within or across the first section of tubing. In another embodiment, the determination is made within or across the second section of tubing. In yet another embodiment, the determination is made within or across the third section of tubing. The determination of whether the system exhibits laminar flow can also be made within or across all the sections of tubing, especially wherein the sections of tubing are made using different material or have different parameters such as internal diameter.

The system temperature, the system pressure for each determination can be measured at each section of tubing wherein the determination is being made. In some embodiments, systems having different tube diameters can have different charts. Systems having multiple charts can have the charts compiled, such as a 3D plot.

A second set of chromatography conditions can be selected, such as during method development to change the separation parameters, e.g., retention time, resolution, etc. This second set of conditions can include the percent carbon dioxide and the percent modifier in the mobile phase, the system temperature, the system pressure, and the mobile phase flow rate. The chromatography system at the second set of chromatography conditions, similar to the first set of conditions, can be checked to determine if it is expected to exhibit laminar flow using at least one chart, e.g., a laminar flow condition chart, showing the relationship between laminar flow and the second set of chromatography conditions for the system. These steps can be repeated until a set of conditions exhibiting laminar flow is determined.

In another embodiment, the present disclosure relates to a method of developing a laminar flow condition chart for a highly-compressible fluid based chromatography system (e.g., mobile phase includes a mixture of CO₂ and a modifier) comprising: (i) providing a chromatography system including a pump for pumping a highly-compressible mobile phase (e.g., a mobile phase containing carbon dioxide and a modifier); a column disposed downstream of the pump and connected to the pump with a first section of tubing; a detector disposed downstream of the column and connected to the column with a second section of tubing; and a back pressure regulator downstream of the detector and connected to the detector with a third section of tubing; (ii) selecting a first set of chromatography conditions including the percent carbon dioxide and the percent methanol in the mobile phase, a system temperature, a system pressure, and a mobile phase flow rate; (iii) determining the volumetric flow rate that equates to a Reynolds number value of about 2000 for the first set of chromatography conditions; (iv) selecting a second set of chromatography conditions wherein the percent carbon dioxide and the percent methanol in the mobile phase, the system temperature, the mobile phase flow rate, or combinations thereof are changed from the first set of conditions; (v) determining the volumetric flow rate that equates to a Reynolds number value of about 2000 for the second set of chromatography conditions; (vi) repeating steps (iv) and (v) until at least one line is capable of being plotted; and (vi) plotting the volumetric flow rates against the mobile phase composition at different temperatures from the sets of chromatographic conditions to generate a laminar flow condition chart.

For any particular highly-compressible fluid based chromatography system (e.g., a CO₂-based chromatography system), at least one laminar flow condition chart can be generated. The laminar flow condition chart can be generated showing Reynolds number plot lines at a defined Reynolds number value, e.g., about 1800 to about 5200 as defined above. In one embodiment, the Reynolds number value for the plot lines is about 2000. In other embodiments, the plot line maybe higher than 2000 but below 5200. For example, the plot line may be 2500 in some cases. The laminar flow condition chart can contain at least one plot line. Each plot line can be based on at least two discrete points. In some embodiments, the chart contains 2, 3, 4, 5, 6, 7, 8, 9, or 10 different plot lines. In some embodiments, each line is based on 2, 3, 4, 5, 6, 7, 8, 9 or 10 different discrete points.

In one embodiment, the methods and charts of the present disclosure can be used to quickly determine, or determine without experimental testing, whether a set of chromatography conditions, e.g., flow conditions, would exhibit laminar or non-laminar flow. A Reynolds number value does not need to be calculated for each set of proposed conditions. Calculating a Reynolds number value for each set of proposed conditions would require experimental determination of measured parameters (e.g., flow rate, composition, pressure, temperature, etc.) and tube dimensions. This is difficult and time-consuming. When a parameter is changed during method development, for example, the Reynolds number value changes and should be evaluated. Changing the set of chromatography conditions can change the flow from laminar to non-laminar, or vice versa. This change can be determined iteratively. However, such an iterative determination is difficult because the calculation requires multiple calculations, such as the determination of the mobile phase viscosity under each new set of conditions.

The methods and the charts of the present disclosure simplify this evaluation and eliminate the need to experimentally determination the Reynolds number. The chart can plot information using different parameters as the x and y axes. These parameters can be the one most often adjusted during method development, e.g., mobile phase composition, flow rate, etc. to make the use of the chart intuitive and quick, e.g., without the need for experimental testing. In some embodiments, the same carbon dioxide chromatography system can have two or more charts that characterize the laminar v. non-laminar flow conditions.

The laminar flow condition chart can also be represented in a spreadsheet wherein an x or y parameter can be entered and the non-entered parameter representing Re=2000 can be provided.

In still more embodiments, a laminar flow condition chart can be generated and used to determine or estimate laminar flow conditions for any highly-compressible fluid based system containing a tube, pipe, such as flow injection analysis system or a flow cell using a highly-compressible fluid with or without a modifier.

In another embodiment, the present disclosure relates to a chromatographic system including (i) a pump for pumping a mobile phase containing carbon dioxide and a modifier at a system pressure and a mobile phase flow rate, (ii) a column disposed downstream of the pump, (iii) a detector disposed downstream of the column, (iv) a back pressure regulator disposed downstream of the detector, wherein at least two of the system components are connected with at least one section of tubing, (v) at least one temperature sensor configured to measure the temperature of the mobile phase in the at least one section of tubing, (vi) at least one heater in thermal communication with the at least one section of tubing, wherein the heater is configured to adjust the temperature of the mobile phase in the at least one section of tubing, and (vi) at least one temperature controller in signal communication with the at least one sensor and the at least one heater. The controller can be configured to receive a first temperature measurement from the sensor, determine if the mobile phase in the at least one section of tubing exhibits laminar flow, wherein the determination is derived from at least one chart showing the relationship between laminar flow and the weight (or volume) percent composition of the mobile phase, the system pressure, the mobile phase flow rate and the first temperature measurement from the at least one sensor, determine a desired temperature of the mobile phase in the at least one section of tubing that exhibits laminar flow, wherein the determination is derived from at least one chart showing the relationship between laminar flow and the weight percent (or volume percent) composition of the mobile phase, the system pressure and the mobile phase flow rate, and send a signal to the at least one heater to adjust the temperature of the mobile phase in the at least one section of tubing to the desired temperature. The at least one section of tubing can include a section of tubing between the column and the detector.

In another embodiment, the present disclosure relates to a chromatographic system wherein at least three or more of the system components disclosed above are connected with at least two or more sections of tubing, the system including at least two or more temperature sensors configured to individually measure the temperature of the mobile phase in the at least two sections of tubing, at least two heaters each in thermal communication with one of the at least two sections of tubing, wherein the heaters are configured to individually adjust the temperature of the mobile phase in each of the at least two sections of tubing, and at least one temperature controller in signal communication with the at least two sensors and the at least two heaters. The controller can be configured to receive first temperature measurements from the at least two sensors, individually determine if the mobile phase in each of the at least two sections of tubing exhibits laminar flow, wherein each determination is derived from at least one chart showing the relationship between laminar flow and the weight (or volume) percent composition of the mobile phase, the system pressure, the mobile phase flow rate and the first temperature measurements from each of the at least two sensors, determine a desired temperature of each mobile phase in the at least two sections of tubing that exhibit laminar flow, wherein each determination is derived from at least one chart showing the relationship between laminar flow and the weight percent (or volume percent) composition of the mobile phase, the system pressure and the mobile phase flow rate, send a signal to each of the at least two heaters to individually adjust the temperature of the mobile phase in the at least two sections of tubing to the desired temperatures. The at least two sections of tubing can include a section of tubing between the column and the detector, and between the detector and the back pressure regulator.

Each temperature sensor can be located anywhere near or at the section of tubing. The temperature sensor can include any traditional temperature sensor used in chromatographic systems to measure the temperature of a mobile phase. The sensor can be capable of measuring the temperature in, near or adjacent to the mobile phase or tubing. For example, the temperature sensor can be a thermocouple, a thermistor or a resistance temperature detector (RTD).

As used herein, the term “heater” refers to any device used in chromatographic systems to heat and/or cool a mobile phase, a tubing section or a component. For example, the heater can be a thermal jacket, a cartridge, a flexible circuit or a coil. Each heater can be in thermal communication with at least one tubing section such that the heater can effectively transfer heat energy to or away from the mobile phase or tubing section(s) and can adjust the temperature therein. In some embodiments, the heater can have the thermal sensor attached to or within the heater.

The temperature controller can include any controller system used in chromatographic systems. The controller can be in signal communication with the sensor(s), the heater(s) or both. For example, the controller can be a P controller, a PI controller, a PID controller, a Fuzzy Logic controller, or combinations thereof. The controller can also be capable of receiving a temperature measurement from a sensor, determining the flow conditions, determining laminar flow conditions, and sending a signal to the heater to adjust the mobile phase temperature to obtain laminar flow conditions. The controller can also have a set of instructions utilized by the controller, wherein the controller is capable of receiving a temperature value from a sensor, determining the flow conditions, determining laminar flow conditions, and adjusting the temperature to achieve laminar flow conditions.

The determination of flow conditions can be derived from at least one chart showing the relationship between laminar flow and the weight percent composition of the mobile phase, as described herein, and the chromatography conditions, e.g., the system pressure, the mobile phase flow rate and the first temperature measurement. In some embodiments, such as for example in analytical SFC systems, the determination of flow conditions can be derived from at least one chart showing the relationship between laminar flow and volume percent composition of the mobile phase and the chromatography conditions.

The determination of a desired temperature of the mobile phase in a section of tubing that exhibits laminar flow can be derived from at least one chart showing the relationship between laminar flow and the weight percent composition of the mobile phase (or alternatively volume percent composition of the mobile phase), as described herein, and the chromatography conditions, e.g., the system pressure, the mobile phase flow rate. The selection of each desired temperature can individually be about, or at least about 1, 2, 3, 4, 5, 6, 7, 8, 9, 10, 11, 12, 13, 14, 15, 16, 17, 18, 19 or about 20° C. greater than, or less than, the boundary or plot line dividing turbulent and laminar flow conditions. These values can be used to define a range, such as from about 1 to about 5° C.

The chromatographic conditions (e.g., mobile phase composition, flow rate, and/or column temperature) can change over the course of a separation. For example, a gradient mobile phase separation may be used in which the concentration of modifier varies over the course of the separation. Also, a temperature gradient separation may be used in which the column temperature varies over the course of the separation. The desired temperature for any section of tubing can be re-determined during the course of a separation as the chromatographic conditions change to maintain flow conditions in a laminar regime. For example, the controller can monitor the chromatographic conditions and make the necessary determinations in real time, and send the appropriate signals to each of the heaters to individually adjust the temperatures of the mobile phase in the affected tubing sections in real time.

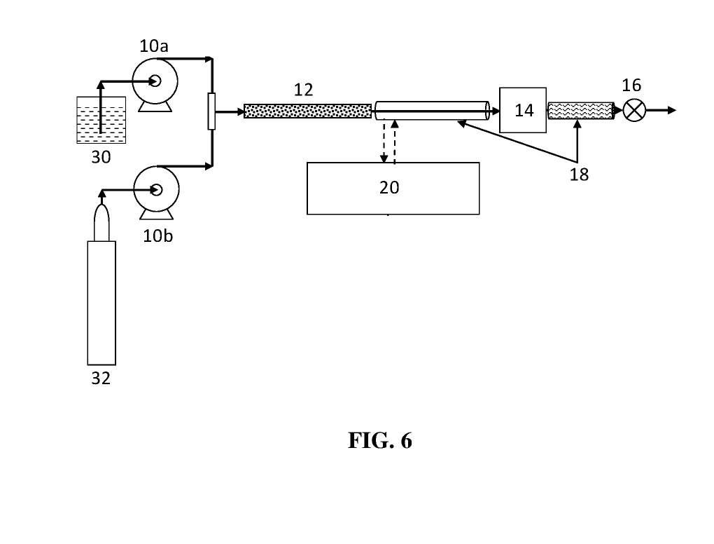

FIG. 6 shows an exemplary chromatography system including a co-solvent pump (10a), a carbon dioxide pump (10b), a column (12), a detector (14), and a back pressure regulator (16). These components are connected by tubing. Sections of the tubing are covered by thermal jackets (18). Each thermal jacket (18) can individually control the temperature of a tubing section. The system includes a feedback temperature controller (20) in signal communication with each sensor (not shown). The controller (20) can determine the flow conditions in each section of tubing by the chromatographic conditions, determine a desired temperature for each section of tubing to ensure laminar flow conditions and send a signal to each thermal jacket (18) to obtain the desired temperatures. The system includes a mobile phase consisting of co-solvent (30) and carbon dioxide (32).

The chromatographic system can use one of the charts, as described herein which show the relationship between laminar flow and the weight percent composition (or volume percent composition) of the mobile phase, to ensure that the flow does not cross into a turbulent regime. The thermal jacket (18) surrounding one or more of the connecting tubes can control the temperature of the mobile phase passing through it. In some embodiments, the temperature of the jacket (18) can be manually controlled by an operator using a table, or set of tables, to determine the flow conditions. In other embodiments, the temperature can be automatically controlled by a controller (20).

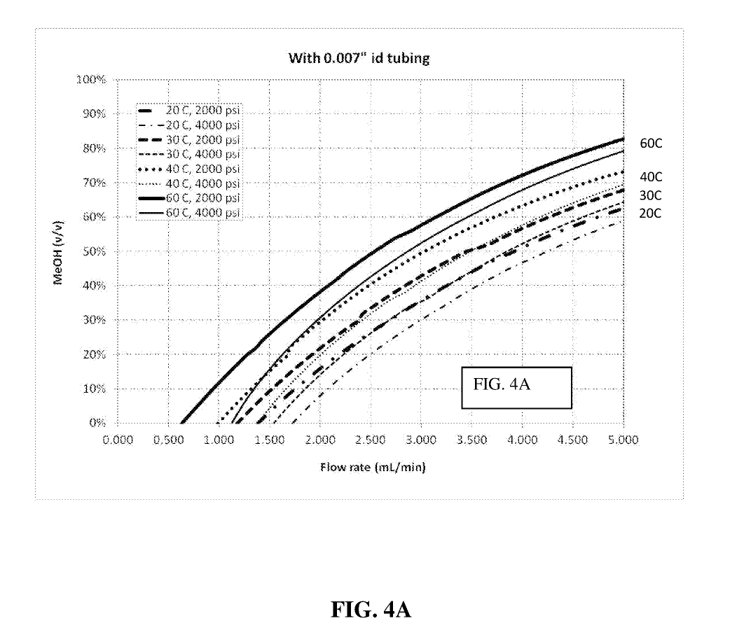

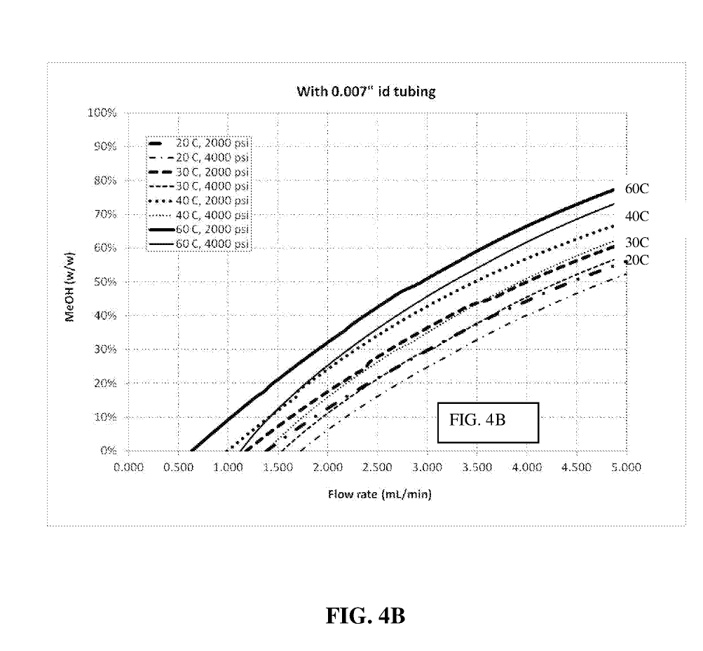

The methods or systems of the present disclosure can correct, minimize or prevent situations where conditions in the tubing generate turbulent flow. The methods or systems can be used to alter the temperature to maintain or transition the flow back to a laminar regime. For example, a method can use the following conditions: a carbon dioxide mobile phase containing 10% (v/v) methanol, a 2000 psi ABPR pressure setting, a 60° C. column temperature and a 1.5 mL/min flow rate. All of the tubing in the chromatography system can have an i.d. of 0.007″. Under these conditions, based on FIG. 4A, the mobile phase exiting the column at 60° C. and entering the tubing is in a non-laminar regime. Unless the temperature of the mobile phase in the tubing is otherwise controlled, it is assumed that the mobile phase temperature will stay close to the column temperature upon exiting the column. Using the present disclosure, a thermal jacket can be used on the tubing exiting the column to adjust (e.g., cool) the temperature of the mobile phase to 20° C. At this temperature, the mobile phase flow conditions are in a laminar regime.

As used herein, the term “about” means that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments.

The disclosures of all cited references including publications, patents, and patent applications are expressly incorporated herein by reference in their entirety.

When an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

The present invention is further defined in the following Examples. It should be understood that these Examples, while indicating preferred embodiments of the invention, are given by way of illustration only.

### EXAMPLES

### Example 1

A laminar flow chart was generated for a supercritical fluid chromatography system using carbon dioxide and methanol as the mobile phase. The SFC system includes the following components: (1) at least 2 pumps, one for carbon dioxide and one for methanol, (2) a mixing device for combining the carbon dioxide and methanol, (3) a tubing for connecting the mixer and an injector, (4) a tubing for connecting the injector and the column inlet, (5) a column, (6) a tubing for connecting the column outlet and a detector, (7) a ABPR (automatic back pressure regulator); (8) and tubing for connecting the detector and the ABPR. One objective is to detect non-laminar flow conditions through any of the connecting tubings and/or devices between the pumps and the ABPR.

The viscosity of different mixtures of carbon dioxide and methanol at different pressures and temperatures was estimated using the property package, (REFPROP) from National Institute of Standards and Technology (NIST). (Ref. E. W. Lemmon, M. O. McLinden, D. G. Friend, Thermophysical Properties of FluidSystems, NIST Chemistry WebBook, NIST Standard Reference 39, 2007). Before the estimation, the mass or molar composition of the mixtures, was determined. Most commercial SFC systems use volume as the index of flow rate and volumetric mixing in determining the composition. Within an SFC system, however, volumetric flow rate and the volumetric composition may change significantly as the density of the mobile phase noticeably varies with slight changes in temperature and/or pressure. As a result, the information supplied by the instrument cannot be applied directly to calculate the Reynolds number inside any particular section of tubing. For the calculation of the Reynolds number, the mass flow rate and the mass or molar composition needs to be estimated based in the available information from the instrument.

The mass flow rate at which the flow turns non-laminar (Re>2000) can be determined from the Reynolds number equation as rewritten:

$$G = \frac{{πμ}_{1} D Re}{4} \qquad ( ii )$$

wherein G is the mass flow in g/min.; μ₁ is the viscosity in g/cm min.; and D is the tube or pipe diameter in cm. To get the boundary condition of the flow rate, the Reynolds number value was set to 2000. A Reynolds number value of 2000 was selected as a conservative estimate to ensure laminar flow conditions and minimize the occurrence of a transition from laminar to non-laminar flow conditions.

The viscosity was calculated from REFPROP software. This calculation required the molar or mass composition of the flow. The volumetric composition as provided by the instrumentation was converted to molar or mass composition. The conversion was performed using the following assumptions, including a pressure of 9000 psi at the pump outlet, a temperature of 13° C. for the carbon dioxide and a 22° C. for the methanol. The selection of 9000 psi can be replace with the highest pressure available in the carbon dioxide based chromatography system. The analytical carbon dioxide based chromatography system used currently has about 9000 psi as the highest pressure value. Selecting the highest pressure value is meant to overestimate the mass flow rate so that the chart overestimates the onset of non-laminar conditions rather than underestimates it.

FIGS. 3-5 were generated at 2000 psi as an example of a worse condition. The conditions were calculated based on physical property data of carbon dioxide at 2000 psi. As pressure increases, viscosity increases and possibilities of having non-laminar flow decreases. 2000 psi was chosen as a representative ABPR pressure. Which means if a method condition is chosen where the flow is laminar at 2000 psi, it will guarantee laminar flow at every point upstream.

Based on the pressure and temperature assumptions, the density of the carbon dioxide and the methanol was estimated to be 1.095 and 0.836 g/mL, respectively, at their respective pump outlets (e.g., ρ_{CO2,PO}; ρ_{CoS, PO}, where PO is the pump outlet and CoS is the co-solvent). The volumetric composition of the carbon dioxide and methanol mixture was converted to mass composition based on these values. After calculating the mass flow rate that should give rise to Re=2000, the consequent volumetric flow rate at the pump outlets was calculated that would give rise to the calculated mass flow rate. This was calculated because the flow rate of an analytical system can be ultimately controlled in terms of volumetric flow rate. That is, the volume percent can be calculated from the weight percent, and can be used in place of the weight percent in embodiments, such as analytical systems, which generally utilize volumetric values.

The volumetric flow rate of the system was calculated from the mass flow rate as:

$$V = \frac{G}{{v}_{{CO}_{2}} \times 1.09 + {v}_{MeOH} \times 0.836} \qquad ( iii )$$

wherein V_{CO}_{₂} is the volume fraction of carbon dioxide and V_{MeoH} is the volume fraction of methanol as measured by an analytical SFC instrument at the pump outlet. FIG. 3 shows the laminar flow condition chart for the carbon dioxide based chromatography system having 0.007 inch internal diameter (i.d.) tubing, and held at a pressure of about 2000 psi. The chart shows laminar flow boundary curves for the system at different temperatures, as a function of mobile phase compositions (v/v) and flow rates (mL/min). The region to the left-hand of a boundary curve represents laminar flow conditions, whereas the region to the right-hand side represents non-laminar flow conditions. Boundary lines or curves are determined for various operating temperatures. As shown in FIGS. 3-5, boundary lines for 20, 30, 40 and 60 degrees C. are provided.

All the mobile phase properties (density, viscosity, etc.) are functions of temperature and pressure. For example, the density at the pump outlet can significantly vary depending on the actual temperature and the pressure of operation. Which means, for the same, accurate, volumetric flow rate from the pumps, the mass flow rates can be different at different pump outlet pressures and pump head temperatures. Similarly, viscosity at the point of interest can vary depending on the operating conditions. The pressure and temperature values were pre-determine for these points to avoid having an infinite number of plots. By fixing these values, a slight over-estimation is built into the method. A pressure value of 9000 psi was considered for the pump-outlet to capture the maximum mass flow rate that can be generated by a given volumetric flow rate setting. A pressure value of 2000 psi was considered for the point of interest to capture a lower viscosity condition, which means higher possibility of getting inside non-laminar conditions. The boundaries of laminar vs. non-laminar conditions shown by the curves in FIG. 3 represent an overestimation.

### Example 2

Once the laminar flow condition chart is generated in Example 1, the method is transferred to the second SFC system using the chart to ensure laminar flow conditions. The second system has components having the same diameter flow paths of the first system.

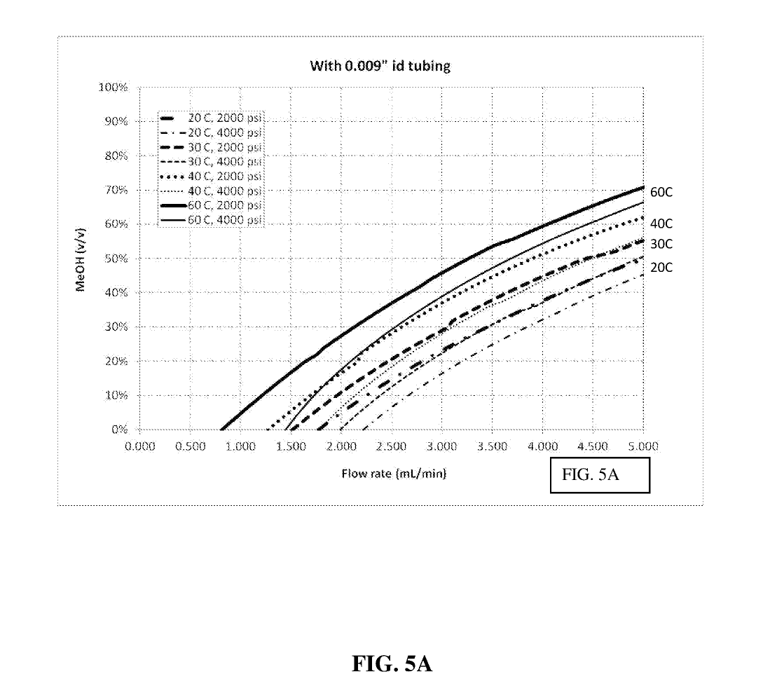

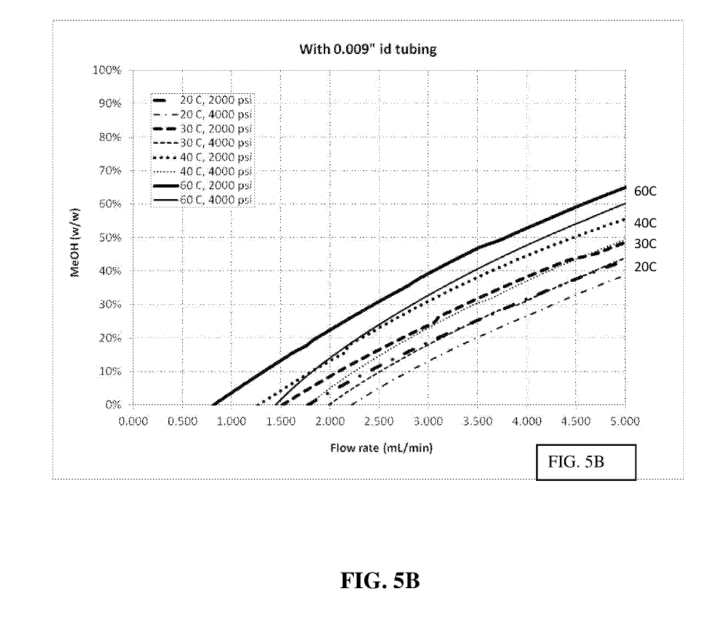

In FIGS. 4 and 5, four different temperatures were considered at two different pressures for each of the temperatures. In addition, FIGS. 4 and 5 also provide data in both volume percent of the mobile phase (FIGS. 4A and 5A) and in weight percent of the mobile phase (FIGS. 4B and 5B). The 20° C. curves are representative of a typical temperature of the tube at the upstream side of the column. The 40° C. and the 60° C. curves are representative of column downstream tubings when the set column temperatures are 40° C. and the 60° C. respectively. It can be instantly noted from the chart that if the flow rate is 2.5 mL/min and above, flow inside a 0.007″ id tubing can reach non-laminar conditions at most of the temperatures, both upstream and downstream side of the column, whenever the mobile phase has 20% by volume or less methanol. On the other hand, if the flow rate is 2.0 mL/min, and the column oven temperature is 40° C., methanol composition lower than 30% by volume will lead to non-laminar flows, whereas higher concentrations will result into laminar flows. Like other charts, these charts represent infinite sets of such information, which can be quickly captured depending on the conditions looked for.

For the second set of conditions, from the chart it is noted that if the flow rate is set below 1.25 mL/min and/or the temperature of the column oven is set below 60° C., non-laminar conditions can be avoided at any part of the system. On the other hand, if the flow rate is more than 2.0 mL/min, the oven temperature is 40° C., the ABPR setting is 2000 psi, and the methanol composition lower than 30%, then non-laminar flows can occur. It will most likely occur near the ABPR.

A second set of conditions could be also be determined based on FIG. 5A using 0.009″ tubings. From the chart, it is noted that all the above mentioned constraints have moved to higher flow rates to reach non-laminar conditions. From the 0.009″ chart, if the flow rate is 3.25 mL/min (in place of 2.5 mL/min) and above, the flow inside a 0.009″ id tubing can reach non-laminar conditions at most of the temperatures, both upstream and downstream of the column whenever the mobile phase has 20% or lesser methanol. On the other hand, if the flow rate is 2.5 mL/min (in place of 2.0 mL/min) and the oven temperature is 40° C., then a methanol composition lower than 30% will lead to non-laminar flows, whereas higher concentrations will result into laminar flows.

### Example 3

To verify the calculated turbulent flow boundaries, experimental measurements were carried out. A description of the experimental set-up can be found in “A study on the onset of turbulent conditions with supercritical fluid chromatography mobile-phases” by Abhijit Tarafder, Journal of Chromatography A 1532 (2018) 182-190, herein incorporated by reference in its entirety. The experimental verification of the turbulent flow boundary for various temperatures ranging from 23 C to 60 C for pressures at 2500 psi (172 bar) and 2900 psi (200 bar) illustrated that the calculated or determined results using the methods for generating a chart as described in Example 1 are within 5% of the experimental results. In general, the experimental results presented in the Journal of Chromatography A 1532 (2018) 182-192 and incorporated by reference herein demonstrate that the charts and turbulent boundary conditions herein provide a good estimate of the onset of turbulent conditions.

### Example 4

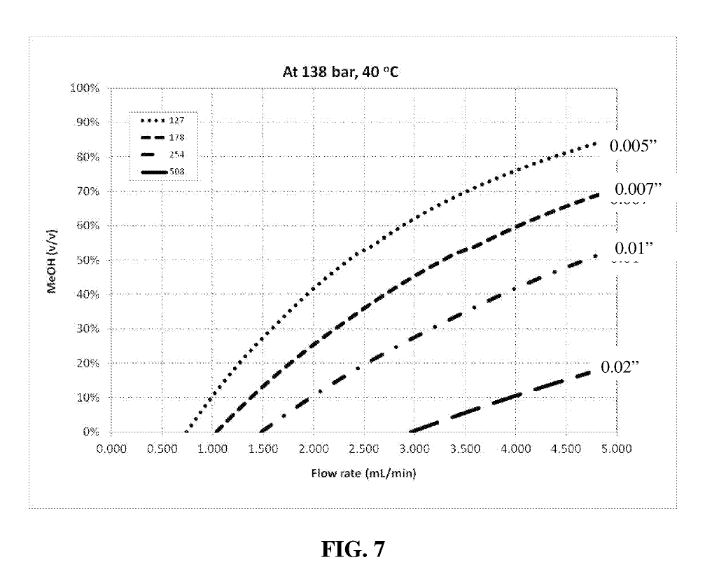

This example looks to the effect of tubing diameter. Internal diameter of connecting tubing can vary from system to system, and within a system between different parts. For example, in some sections of a system, the tubing can have 0.007 in (178 microns) tubing for example in locations connecting various components, whereas the tubing diameter prior to the injector is larger 0.01 in (254 microns). Decreasing tubing diameter increases flow velocity (assuming no change in mass flow). Thus, with decreasing tubing internal diameter there will be onset of turbulent conditions at low flowrates. FIG. 7 demonstrates how varying tubing diameter affects the turbulent zone, assuming the same surface roughness of the tubing. For example with 127 micron tubing internal diameter flow can be turbulent with 15 volume percent methanol co-solvent event at a low flow rate of 1.5 mL/min. With increasing co-solvent concentration the effect of tubing internal diameter in determining the onset of turbulence becomes more prominent. For example, with neat CO₂ increasing tubing internal diameter from 127 to 178 microns will push the turbulence onset limit by 0.25 mL/min. With 30 volume percent methanol, on the other hand, the limit will be pushed by 0.7 mL/min.

What is claimed is:

1. A method for developing a carbon dioxide based chromatography separation comprising:
(i) providing a chromatography system including:
a pump for pumping a mobile phase containing carbon dioxide and a modifier;
an injector disposed downstream of the pump;
a column disposed downstream of the injector;
a detector disposed downstream of the column; and
a back pressure regulator disposed downstream of the detector,
wherein at least two of the system components are connected with at least one section of tubing;
(ii) selecting a first set of chromatography conditions including a first percent carbon dioxide and a first percent modifier in the mobile phase, a first system temperature, a first system pressure, and a first mobile phase flow rate; and
(iii) determining if the chromatography system at the first set of chromatography conditions exhibits laminar flow, wherein the determination is derived from at least one chart showing the relationship between laminar flow and the first set of chromatography conditions for the system.

2. The method of claim 1, further comprising:
(iv) selecting a second set of chromatography conditions including a second percent carbon dioxide and a second percent modifier in the mobile phase, a second system temperature, a second system pressure, and a second mobile phase flow rate;
(v) determining if the chromatography system at the second set of chromatography conditions exhibits laminar flow, wherein the determination is derived from at least one chart showing the relationship between laminar flow and the second set of chromatography conditions for the system.

3. The method of claim 2, further comprising repeating steps (iv) and (v) until a set of conditions exhibiting laminar flow is determined.

4. The method of claim 1, wherein the at least one chart is a laminar flow condition chart showing Reynolds number plot lines at a defined Reynolds number value for different sets of chromatography conditions.

5. The method of claim 4, wherein the defined Reynolds number value is about 2,000.

6. The method of claim 4, wherein the defined Reynolds number value is about 2,500.

7. The method of claim 1, wherein the modifier is methanol.

8. The method of claim 1, wherein the determination of whether the system exhibits laminar flow is made within the at least one section of tubing or across a system component.

9. The method of claim 1, wherein the determination of whether the system exhibits laminar flow is made within all of the sections of tubing.

10. The method of claim 8, wherein the first system temperature and the first system pressure is measured at the at least one section of tubing.

11. The method of claim 1, wherein at least three of the system components are connected with at least two sections of tubing.

12. The method of claim 1, wherein all of the system components are connected with separate sections of tubing.

13. A method for developing a carbon dioxide based chromatography separation comprising:
(i) providing a chromatography system including:
a pump for pumping a mobile phase containing carbon dioxide and a modifier;
an injector disposed downstream of the pump and connected to the pump with a first section of tubing;
a column disposed downstream of the injector and connected to the injector with a second section of tubing;
a detector disposed downstream of the column and connected to the column with a third section of tubing; and
a back pressure regulator downstream of the detector and connected to the detector with a fourth section of tubing;
(ii) selecting a first set of chromatography conditions including a percent carbon dioxide and a percent modifier in the mobile phase, a system temperature, a system pressure, and a mobile phase flow rate; and
(iii) determining if the chromatography system at the first set of chromatography conditions exhibits laminar flow, wherein the determination is derived from at least one chart showing the relationship between laminar flow and the first set of chromatography conditions for the system.

14. A method of developing a laminar flow condition chart for a carbon dioxide based chromatography system comprising:
(i) providing a chromatography system including:
a pump for pumping a mobile phase containing carbon dioxide and a modifier;
an injector disposed downstream of the pump and connected to the pump with a first section of tubing
a column disposed downstream of the injector and connected to the injector with a second section of tubing;
a detector disposed downstream of the column and connected to the column with a third section of tubing; and
a back pressure regulator downstream of the detector and connected to the detector with a fourth section of tubing;
(ii) selecting a first set of chromatography conditions including a first percent carbon dioxide and a first percent modifier in the mobile phase, a first system temperature, a first system pressure, and a first mobile phase flow rate;
(iii) determining the volumetric flow rate that equates to a Reynolds number value of about 2000 for the first set of chromatography conditions;
(iv) selecting a second set of chromatography conditions wherein a second percent carbon dioxide and a second percent modifier in the mobile phase, a second system temperature, a second mobile phase flow rate, or combinations thereof are changed from the first set of conditions;
(v) determining the volumetric flow rate that equates to a Reynolds number value of about 2000 for the second set of chromatography conditions;
(vi) repeating steps (iv) and (v) until at least one line is capable of being plotted; and
(vii) plotting the volumetric flow rates against the mobile phase composition at different temperatures from the sets of chromatographic conditions to generate a laminar flow condition chart.

15. A chromatographic system comprising:
(i) a pump for pumping a mobile phase containing carbon dioxide and a modifier at a system pressure and a mobile phase flow rate;
(ii) a column disposed downstream of the pump;
(iii) a detector disposed downstream of the column;
(iv) a back pressure regulator disposed downstream of the detector, wherein at least two of the system components are connected with at least one section of tubing;
(v) at least one temperature sensor configured to measure the temperature of the mobile phase in the at least one section of tubing;
(vi) at least one heater in thermal communication with the at least one section of tubing, wherein the heater is configured to adjust the temperature of the mobile phase in the at least one section of tubing; and
(vi) at least one temperature controller in signal communication with the at least one sensor and the at least one heater, wherein the controller is configured to
receive a first temperature measurement from the sensor,
determine if the mobile phase in the at least one section of tubing exhibits laminar flow, wherein the determination is derived from at least one chart showing the relationship between laminar flow and the weight or volume percent composition of the mobile phase, the system pressure, the mobile phase flow rate and the first temperature measurement from the at least one sensor;
determine a desired temperature of the mobile phase in the at least one section of tubing that exhibits laminar flow, wherein the determination is derived from at least one chart showing the relationship between laminar flow and the weight or volume percent composition of the mobile phase, the system pressure, and the mobile phase flow rate;
send a signal to the at least one heater to adjust the temperature of the mobile phase in the at least one section of tubing to the desired temperature.

16. The system of claim 15, wherein the at least one section of tubing includes a section of tubing between the column and the detector.

17. The system of claim 15, wherein at least three or more of the system components are connected with at least two or more sections of tubing, the system comprising:
at least two or more temperature sensors configured to individually measure the temperature of the mobile phase in the at least two sections of tubing;
at least two heaters each in thermal communication with one of the at least two sections of tubing, wherein the heaters are configured to individually adjust the temperature of the mobile phase in each of the at least two sections of tubing; and
at least one temperature controller in signal communication with the at least two sensors and the at least two heaters, wherein the controller is configured to
receive first temperature measurements from the at least two sensors,
individually determine if the mobile phase in each of the at least two sections of tubing exhibits laminar flow, wherein each determination is derived from at least one chart showing the relationship between laminar flow and the weight or volume percent composition of the mobile phase, the system pressure, the mobile phase flow rate and the first temperature measurements from each of the at least two sensors;
determine a desired temperature of each mobile phase in the at least two sections of tubing that exhibit laminar flow, wherein each determination is derived from at least one chart showing the relationship between laminar flow and the weight or volume percent composition of the mobile phase, the system pressure and the mobile phase flow rate;
send a signal to each of the at least two heaters to individually adjust the temperature of the mobile phase in the at least two sections of tubing to the desired temperatures.

18. The system of claim 17, wherein the at least two sections of tubing includes a section of tubing between the column and the detector, and between the detector and the back pressure regulator.
